(19) United States
(12) Patent Application Publication
(10) Pub. No.: US 2007/0240348 A1
(43) Pub. Date: Oct. 18, 2007

(54) Stretcher frame with tacking surface

(76) Inventor: Laurence S. Rubin, Hackensack, NJ (US)

Correspondence Address: KATTEN MUCHIN ROSENMAN LLP, 575 MADISON AVENUE, NEW YORK, NY, 10022-2585, US

(21) Appl. No.: 11/786,628

(22) Filed: Apr. 12, 2007

Related U.S. Application Data
(60) Provisional application No. 60/791,382, filed on Apr. 12, 2006.

(51) Int. Cl. G09F 17/00

(52) U.S. Cl. 40/603

(57) ABSTRACT

A stretcher frame is configured with a plurality of frame members each having a channel in the rearward surface of the frame member, and a wood strip that is mounted in the channel and has a rearward tacking surface that is raised from the rearward surface of the frame member.

### CROSS-REFERENCE TO RELATED APPLICATION

This application is a non-provisional counterpart to and claims priority to the U.S. Ser. No. 60/791,382 filed on Apr. 12, 2006, the contents of which are hereby incorporated in their entirety.

### BACKGROUND OF THE INVENTION

1. Field of the Invention

The invention relates to frame assemblies and more particularly to a frame assembly for supporting a sheet of canvas, or the like, stretched thereover and attached thereto.

2. Description of the Prior Art

It is customary to stretch a sheet of canvas over a generally rigid structure or framework in preparation for painting on the canvas. Unlike a frame that clamps a picture element inside the frame boundary, the structure for stretching a sheet of canvass uses the exterior of the structure. A sheet of canvass or at least a portion of canvass is stretched over the over the structure so that a front side of canvass is visible. The canvass is then secured to the back of the stretcher frame with a chief aim being to make the canvass as taught as possible to provide a stable work surface for the artist. The term “stretcher frame” is applied to such frames.

Unfortunately, standard stretcher frames often rack out of “square” and/or warp out of plane when the canvas is tightly stretched thereon. After mounting of the canvas on the frame, the frame often warps, and the tighter the canvas is stretched, the more likely it is that the frame will warp. Furthermore, wood frames have the disadvantages of warping, splintering, and not being uniform. Worse yet, on occasion wooden frames break under the tension of the stretched canvas.

In an effort to overcome such problems, frame members have been made from extruded aluminum sections, which are mitered in suitable lengths and arranged to form a completed framework for the picture element. The frame members are assembled into a whole frame by means of corner brackets, and clip bodies, typically in the form of leaf springs adapted to fix a canvas to a frame. Sometimes, an aluminum frame may be provided with a wood strip allowing an artist to achieve the desired tensions to canvas stretched over the frame. Typically, a wood strip has a relatively broad structured surface that may limit and interfere with the adjustment of canvas on the frame. Furthermore, the known aluminum frames typically require using additional tensioning tools such “stretcher keys” and or “L corner brackets” to provide the desired tension to a sheet of canvas stretched over a frame.

A need, therefore, exists for an improved stretcher frame that is made from a combination of materials allowing for a sheet of canvas to remain uniform under tension, to not warp, splinter, and/or break under tension.

Another need exists for a stretcher frame that can be easily assembled in an adjustable manner to provide an artist with the desired shape and dimensions.

Still another need exists for a stretcher frame that has a raised back-tacking surface presenting an artist user with a tactile feeling that facilitates finding the desired position of a sheet of canvas stretched over the stretcher frame.

### SUMMARY OF THE INVENTION

The inventive stretcher frame configured with multiple relatively rigid frame sections each of which is provided with a wood block strip meets these needs. The wood strip is slidably mounted in a strip channel, which is formed on a rearward surface of each frame member, so that its tacking surface is raised from the rearward surface of the frame member. The raised position of the tacking surface allows the artist to feel which part of the stretched sheet of canvas is raised. Consequently, based on the tactile feeling, the artist easily ascertains the correct place for tacking/stapling the sheet of canvas to the frame.

The rigid frames members preferably are made from extruded aluminum. Alternatively, other materials, such as plastic, can be used when tensile forces applied to the inventive frame are rather insignificant. The wood strip may be made from any softwood including, among others, pine, fir, larch, cypress, redwood and yew. Configuring the inventive frame with a combination of rigid materials used for forming frame members and softwood for the block strip allows the artist to have the lightweight strength and uniformity of aluminum with the soft receptive tacking surface of the wood strip.

The inventive frame members can be easily assembled together. Each of the frame members is configured with two guide channels provided between the frontward and rearward surfaces of the frame member. The guide channels each are adapted to receive a leg of an L-shaped bracket, the other leg of which is slidably received in the respective guide channel of the adjacent frame member. Thus, a pair of L-shaped brackets allows for easy coupling of the adjacent frame members.

Typically, a frame is rectangular, however, it may have other shapes such as oval, round and other regular or non-regular shapes. Accordingly, each of the frame members may be configured as a segment which, when coupled to other segments, forms a portion of the desired shape of the inventive frame.

The strip channel adapted to receive the inventive wood strip is adjacent to the guide channels and dimensioned to slidably receive the wood strip that substantially fills the strip channel. The wood strip is configured with a pair cutoff regions defining therebetween a relatively narrow rearward tucking surface, which is dimensioned to protrude through an opening, formed in the rearward surface of each frame member. Advantageously, the tucking surface is smooth and spaced from the outer side of the frame member, which bridges the rearward and frontward surface, at about 1 and ⅛″. A relatively broad aluminum structured surface, a relatively narrow smooth wooden surface, which protrudes rearwards from the frame member, and the above-mentioned distance between the outer side of the member and the opposing edge of the wood strip, in combination, allow the user to apply substantial tensile forces to a sheet of canvas without detrimentally affecting the inventive frame.

The aforementioned features and advantages of the invention will be pointed out with particularity, and will become obvious from the following detailed description of the invention, taken in conjunction with the accompanying drawings, which form an integral part thereof.

### BRIEF DESCRIPTION OF THE DRAWINGS

FIG. 1 is an elevated front view of the inventive stretcher frame;

FIG. 2 is an elevated rear view of the inventive stretcher frame;

FIG. 3 is a perspective view of adjacent frame members coupled together;

FIG. 4 an end view of the frame member; and

FIG. 5 is a view of adjacent frame members coupled together.

### DETAILED DESCRIPTION

Reference will now be made in detail to several embodiments of the invention that are illustrated in the accompanying images. The images are in simplified form and are not to precise scale. For purposes of convenience and clarity only, directional terms, such as top, bottom, left, right, up, down, above, below, proximal, and distal may be used with respect to the drawings. These and similar directional terms should not be construed to limit the scope of the invention in any manner. The words “connect,” “couple,” “attach,” and similar terms do not necessarily denote direct and immediate connections, but also include connections through mediate elements or devices.

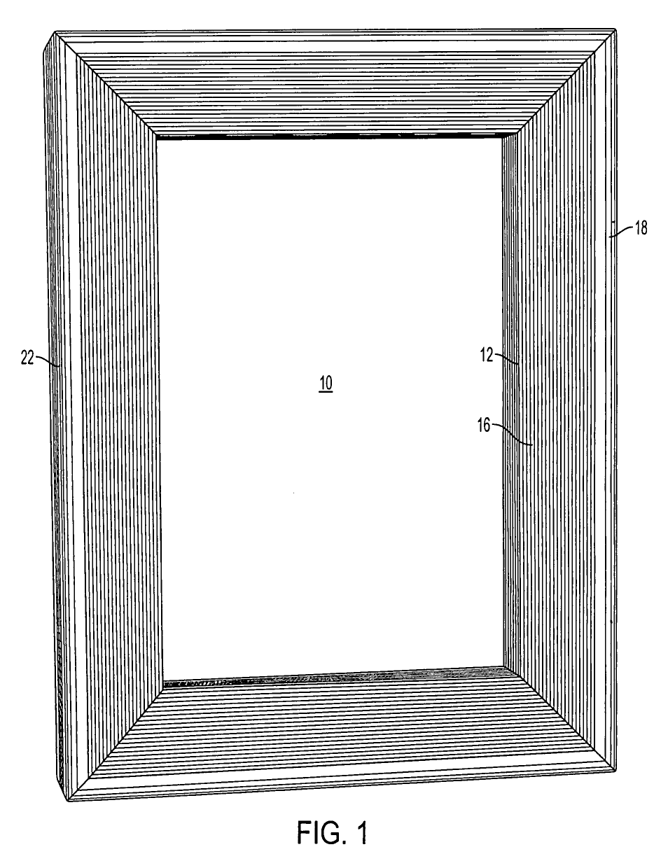

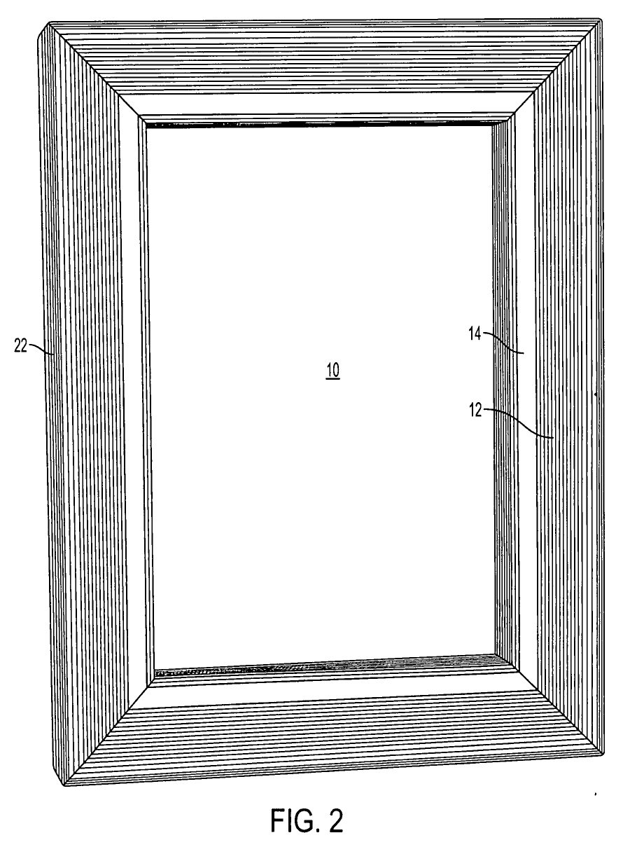

Referring to FIGS. 1 and 2, a stretcher frame 10 configured in accordance with the invention includes a plurality of individual frame members 12 that are coupleable together, as will be explained hereinbelow. Each of frame members 12 is formed with a frontward surface 16 and an opposite rearward surface 20 shown in FIGS. 1 and 2, respectively. An artist's canvas is produced by mounting a sheet of canvas on frontward surfaces 16 (FIG. 1) of respective frame members 12. Since the sheet of canvas is larger than stretcher frame 10, the edge portions of this sheet are further bent over outer sides 22 of stretcher frame 10 each of which bridges a respective pair of opposite frontward and rearward surfaces 16 and 20, respectively. Finally, the artist tacks or staples the bent edge portions to rearward surfaces 20 of stretcher frame 10 under tension, as will be explain hereinbelow.

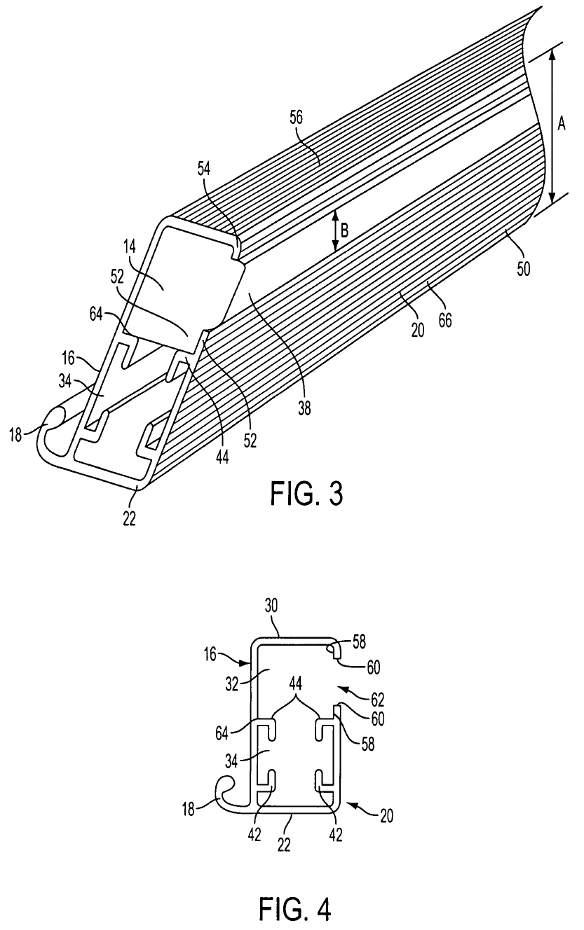

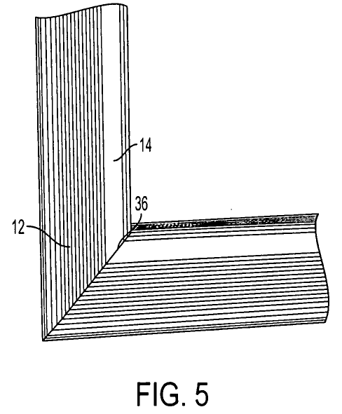

Turning now to FIGS. 3-5, each of frame members 12 of rectangularly shaped frame 10 is configured with an inner strip channel 32 (FIG. 4) slidably receiving a wood strip 14 (FIG. 3). The strip 14 and strip channel 32 are shaped and dimensioned so that rearward-tacking surface 38 (FIG. 3) of strip 14 extends from rearward surface 20 of frame member 12. When the edge portion of a sheet of canvas is brought into contact with raised tacking surface 38 of strip 14, the artist tactilely senses which part of the canvas is raised and easily ascertains the desired position for attaching the canvas to the strip.

The wood strip 14 is preferably made from softwood including, among others, pine, fir, larch, cypress, redwood and yew. The wood strip 14 has a relatively high coefficient of friction minimizing, thus, undesirable displacement of the sheet of canvas relative to frame 10 before and after stapling the canvass to tacking surface 38. Spacing an outer edge 44 of tacking surface 38 from a rearward edge 50 of outer side 22 of frame 10 at a distance varying between about 1⅙″-1 1/10″, and particularly at about 1⅛″, permits the artist to put more tension on the canvas without detrimentally affecting uniformity of frame 10. The portion 64 (FIG. 3) of rearward surface 20 of frame member 12 extending between the inner edge of wood strip 14 and inner side 30 of frame member 12 may vary but preferably is substantially narrower than a portion 66 extending between edge 44 of strip 14 and outer side 22 of frame member 12. Furthermore, portion 64 is narrower than wood strip 14.

The raised tacking surface 38 of wood strip 14 is preferably flat and smooth, has slightly rounded edges and extends from rearward surface 20 of frame member 12 at a distance between about 0.5-2 mm. The width “B” of strip 14 is substantially smaller than the width “A” of rearward surface 20 of strip 14 with the width ratio of A/B varying between about 2:1 and 2.2:1.

The wood strip 14 is provided with two upper and lower cutout portions 52 (FIG. 3) extending along the entire length of strip 14 and defining raised tacking surface 38 therebetween. Each of cutout portions 52 may have a substantially L-shaped cross-section provided with one part 54 that abuts an inner side segment 58 (FIG. 4) of rearward surface 20 of frame member 12 and other part 56 (FIG. 3) that is supported by an end region 60 of surface 20. The end regions 60 of frame member's rearward surface 20 are spaced from one another to define an opening 62 (FIG. 4) formed in rearward surface 20 so that raised tacking surface 38 of wood strip 14 projects through it.

The strip channel 32 (FIG. 4) is defined between the inner surface of inner side 30 of frame member 12, the inner surface of frontward surface 16 of frame member 12 and a pair of support surfaces 64 of respective L-shaped lips 44 facing the inner surface of inner side 30 of frame member 12. In addition to lips 44, the interior of frame member 12 also has a pair of L-shaped lips 42 each aligned with a respective one of lips 44. The aligned lips 44 and 42 of each pair define a passage 34 shaped and dimensioned to receive one leg of an L-shape bracket (not shown), the other leg of which is received in a similarly formed passage of adjacent frame member 12, when the adjacent frame members 12 are coupled together, as illustrated in FIG. 5. The configuration of guide passage 32 and passages 34 can be modified in accordance with the cross-section of wood strip 14 and elements for coupling the adjacent frame members that may have a variety of shapes and forms. For example, instead of a rectangularly shaped wood strip 14, as shown in FIG. 3, it may have a generally round or oval shape except for raised rearward surface 38.

The wood strip 14 has a length corresponding to the length of guide channel 32 and is formed with a beveled end portion (FIG. 3) extending parallel to the end portion of frame 12 and complementary to the beveled end portion of the adjacent frame 12 in the coupled state of the adjacent frame members 12.

The frontward surface 16 (FIG. 4) of frame member 12 has a J-shaped flange 18 providing a reliable support surface for a canvas. The outer periphery of frame member 12 including frontward, rearward, outer and inner sides 16, 20, 22 and 30, respectively, each have a structured surface improving friction between the mounted canvas and frame 10. The structured surface may have corrugations—alternating valleys and peaks, or be provided with any other pattern of formations. A combination of smooth surface 38 (FIG. 3) of strip 14 and structured surface of frame member 12 has been found particularly suitable for proper tensioning of a canvas on frame 10. However, it is also possible to have tacking surface 38 of strip 14 structured, while providing the outer periphery of frame member 12 with smooth or structured configuration.

While frame members 12 are preferably made from aluminum, other metals or plastics can be successfully utilized within the scope of the invention. Furthermore, instead of rectilinear frame member 12, the latter can have any other desirable shape provided, of course, that individual frame members 12 would be attachable to one another.

The stretcher frame 10, thus, is light, cost-efficient, and capable of remaining uniform during the tensioning of the canvas. The wood/aluminum combination of the rearward surface of strip 14 are smooth and structured. Strip 14 is spaced a substantial distance from the outer edge of frame member 12. Thus, the raised position of the strip's tacking surface 38 relative to frame member 12 allow the artist to apply a substantial tensile force to the canvas during its tensioning without deforming frame 10. Overall, frame 10 is characterized by uniformity and lack of warping and splintering.

The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features.

What is claimed is:

1. A stretcher frame comprising:
a plurality of frame members each frame member having a channel in a rearward surface of the frame member;
an insert mounted in the channel of each frame member, the insert comprising a rearward tacking surface for holding a drawing surface, the surface being raised from a rearward surface of the respective frame member.

2. The stretcher of claim 1, wherein the insert comprises a first cut-out for receiving a first portion of the respective frame member.

3. The stretcher frame of claim 2, wherein the insert comprises a second cut-out for receiving a second portion of the respective frame member; the first and second cut-outs defining the rearward tacking surface.

4. The stretcher frame of claim 1, where the rearward tacking surface is substantially planar.

5. The stretcher frame of claim 1, wherein the insert is slideably mountable with channel.

6. The stretcher frame of claim 1, wherein the insert is a wood strip.

7. The stretcher frame of claim 6, wherein the plurality of frame members are made of metal.

8. A stretcher frame for securing a canvas in a stretched state, the stretcher frame comprising:
a frame member having a substantially rigid shape and a pair of edges defining a retaining structure;
an insert retained by the retaining structure, the insert comprising a surface for tacking the canvass.

9. The stretcher frame of claim 8, wherein the frame member comprises a front and rear surface, the retaining structure being disposed in the rear surface.

10. The stretcher frame of claim 8, wherein the insert comprises a raised portion comprising the surface for tacking the canvass.

11. The stretcher frame of claim 10, wherein the insert comprises a pair of cut-outs defining the raised portion that engages the retaining surface.

12. The stretcher frames of claim 8, wherein the frame member comprises a flange for supporting the canvass.

13. The stretcher frame of claim 8, wherein the frame member is made of a metal and the insert is made of a wood.

14. A stretcher frame comprising:
a plurality of rigid members defining a frame;
an insert slideably mounted in each of the members, the insert having a raised portion;
the raised portion defining a tacking surface for mounting a canvass.

15. The stretcher frame of claim 14, wherein each of the members has a rearward surface that has a width that is at least twice of a width of the raised portion.

16. The stretcher frame of claim 14, wherein the raised portion is raised at least 0.5 mm relative to other portions of the insert.

17. The stretcher frame of claim 14, wherein the raised portion may be detected by a person where it is covered by the canvass.

18. The stretcher frame of claim 14, wherein each member comprised a flange for supporting the canvass.
